(19) United States
(12) Patent Application Publication
(10) Pub. No.: US 2022/0045574 A1
(43) Pub. Date: Feb. 10, 2022

(54) DRIVING DEVICE

(71) Applicant: JTEKT CORPORATION, Kariya-shi (JP)

(72) Inventors: Akitomo IWATA, Kariya-shi (JP); Yoshinori SUZUKI, Okazaki-shi (JP); Keita NOMURA, Kariya-shi (JP); Akira NAKASHIMA, Okazaki-shi (JP); Kuniko HAYASHI, Kariya-shi (JP); Akira SATO, Kariya-shi (JP); Yusei KONDA, Ena-shi (JP); Minh Phuong DAO, Kariya-shi (JP); Yoshihide KAMIYA, Toyota-shi (JP); Van Tinh NGUYEN, Tokai-shi (JP)

(73) Assignee: JTEKT CORPORATION, Kariya-shi (JP)

(21) Appl. No.: 17/385,087

(22) Filed: Jul. 26, 2021

(30) Foreign Application Priority Data
Aug. 6, 2020 (JP) 2020-134061

(51) Int. Cl. H02K 7/116; H02K 7/00

(52) U.S. Cl. CPC H02K 7/116; H02K 7/003

(57) ABSTRACT

A driving device includes an electric motor, a drive gear, a deceleration mechanism, a driven gear, and a housing. At least either one of the drive gear and the driven gear is provided as a helical gear. The deceleration mechanism includes a plurality of reduction gear shafts, a plurality of bearings, and a biasing member provided for at least any one of the bearings. The biasing member axially biases an outer ring of the at least any one of the bearings that supports at least either one of end parts of the shaft portion of a corresponding one of the reduction gear shafts, the end parts including an end part on the large-diameter gear wheel side and an end part on the small-diameter gear wheel side.

### CROSS-REFERENCE TO RELATED APPLICATION

This application claims priority to Japanese Patent Application No. 2020-134061 filed on Aug. 6, 2020, incorporated herein by reference in its entirety.

### BACKGROUND

### 1. Technical Field

The present disclosure relates to a driving device for driving a target with an electric motor being used as a driving source.

### 2. Description of Related Art

In recent years, automobiles have been motorized, and driving devices having various configurations for driving wheels with an electric motor being used as a driving source have been proposed. A driving device (an electric drive unit for a vehicle) described in Japanese Unexamined Patent Application Publication No. 2019-173833 (JP 2019-173833 A) is configured to transmit rotation of a rotor shaft of an electric motor to right and left output shafts through a deceleration mechanism and a differential device. The deceleration mechanism has a dual counter structure including a pair of reduction gear shafts each configured such that large and small helical gears having different diameters are provided in a counter shaft placed in parallel to the rotor shaft. A ring gear is attached to a differential case for a differential device by bolts, and the helical gear having a small diameter and provided in each counter shaft meshes with the ring gear. Each counter shaft is supported rotatably relative to a housing via a bearing (a ball bearing or a needle bearing).

### SUMMARY

In a case where the rotating shaft is supported rotatably relative to the housing via the bearing, a locking structure configured to lock an inner ring or an outer ring of the bearing by a snap ring fitted in a groove provided in a rotating shaft or a housing is often used. In such a locking structure, an axial backlash (gap) is inevitably caused in the inner ring or the outer ring of the bearing. Like the driving device described in JP 2019-173833 A, in a case of a structure where a torque of one electric motor is transmitted to a ring gear via a pair of reduction gear shafts each including large and small helical gears with different diameters, when an axial relative position between counter shafts provided in a pair is displaced due to an axial backlash in the bearing, for example, a difference occurs between meshing states of the ring gear with the reduction gear shafts. This might cause inequality between a torque to be transmitted to the ring gear from one of the reduction gear shafts and a torque to be transmitted to the ring gear from the other one of the reduction gear shafts. When the driving device is designed so that respective strengths of the reduction gear shafts are secured even when such an unequal state of transmission torque occurs, the cost or weight of the device increases.

The present disclosure provides a driving device configured to transmit a torque of one electric motor via a plurality of reduction gear shafts, the driving device being able to equalize torques to be transmitted via a plurality of reduction gear shafts.

A driving device according to an aspect of the present disclosure includes an electric motor, a drive gear, a deceleration mechanism, a driven gear, and a housing. The drive gear is configured to rotate together with an output rotating shaft of the electric motor in an integrated manner. The deceleration mechanism is configured to decelerate rotation of the drive gear. The driven gear is configured to be driven to rotate by a torque of the electric motor, the torque being transmitted via the deceleration mechanism. In the housing, the deceleration mechanism and the driven gear are accommodated. At least one of the drive gear and the driven gear is provided as a helical gear. The deceleration mechanism includes: a plurality of reduction gear shafts each including a large-diameter gear wheel meshing with the drive gear and a small-diameter gear wheel meshing with the driven gear; a plurality of bearings provided such that the bearings support respective end parts of the reduction gear shaft to the housing; and a biasing member provided for at least any one of the bearings. Each of the reduction gear shafts is provided such that the large-diameter gear wheel and the small-diameter gear wheel are concentrically provided in a shaft portion placed in parallel to the output rotating shaft. Each of the bearings includes: an outer ring held by the housing; an inner ring outwardly engaged with the shaft portion of a corresponding one of the reduction gear shafts; and a plurality of rolling elements placed between the inner ring and the outer ring. The biasing member axially biases the outer ring of the at least any one of the bearings that supports at least either one of end parts of the shaft portion of a corresponding one of the reduction gear shafts, the end parts including an end part on the large-diameter gear wheel side and an end part on the small-diameter gear wheel side.

In the present aspect, in a driving device configured to transmit a torque of one electric motor via a plurality of reduction gear shafts, it is possible to equalize torques to be transmitted by the reduction gear shafts to each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating a schematic exemplary configuration of a vehicle provided with a driving device according to a first embodiment of the present disclosure:

FIG. 2 is a sectional view illustrating an exemplary configuration of the driving device;

FIG. 3A is a configuration diagram illustrating a drive gear, a deceleration mechanism, and a driven gear with a section of part of a housing;

FIG. 3B is an explanatory view schematically illustrating a meshing state where the drive gear, the deceleration mechanism, and the driven gear are meshed;

FIG. 4A is a partial enlarged view illustrating a first bearing and its peripheral part in an enlarged manner;

FIG. 4B is a partial enlarged view illustrating a third bearing and its peripheral part in an enlarged manner;

FIG. 5A is a configuration diagram illustrating a drive gear, a deceleration mechanism, and a driven gear in a second embodiment of the present disclosure together with a section of part of a housing;

FIG. 5B is a partial enlarged view of FIG. 5A;

FIG. 5C is a partial enlarged view of FIG. 5A;

FIG. 6A is a configuration diagram illustrating a drive gear, a deceleration mechanism, and a driven gear in a third embodiment of the present disclosure together with a section of part of a housing;

FIG. 6B is a partial enlarged view of FIG. 6A;

FIG. 6C is a partial enlarged view of FIG. 6A;

FIG. 7A is a configuration diagram illustrating a drive gear, a deceleration mechanism, and a driven gear in a fourth embodiment of the present disclosure together with a section of part of a housing;

FIG. 7B is a partial enlarged view of FIG. 7A; and

FIG. 7C is a partial enlarged view of FIG. 7A.

### DETAILED DESCRIPTION OF EMBODIMENTS

### First Embodiment

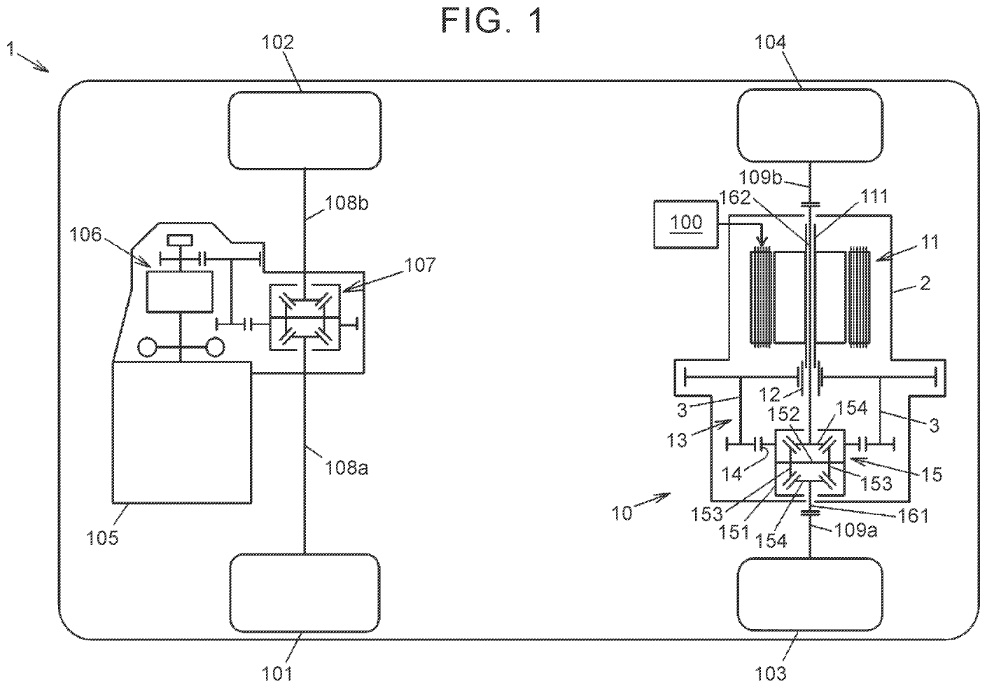

A first embodiment of the present disclosure will be described with reference to FIGS. 1 to 4B. Note that the embodiment described below shows a preferred concrete example on performing the present disclosure. There are some parts that specifically show various technical matters that are technically preferable, but the technical scope of the present disclosure is not limited to such a concrete example.

FIG. 1 is a schematic view illustrating a schematic exemplary configuration of a vehicle provided with a driving device according to the first embodiment of the present disclosure. The vehicle 1 is a four-wheel drive vehicle that can drive right and left front wheels 102, 101 and right and left rear wheels 104, 103. The right and left front wheels 102, 101 are driven by an engine 105 as a main drive source, and the right and left rear wheels 104, 103 are driven by a driving device 10 including an electric motor 11 as an auxiliary drive source. The electric motor 11 of the driving device 10 is controlled by a control device 100.

The driving force of the engine 105 is transmitted from a transmission 106 to a differential device 107 and is distributed into the right front wheel 102 and the left front wheel 101 from the differential device 107 via right and left drive shafts 108b, 108a. Note that, as the main drive source, a high-output electric motor may be used, or a so-called hybrid electric motor constituted by an engine and a high-output electric motor in combination may be used.

The driving device 10 includes an electric motor 11 including a motor shaft 111 as an output rotating shaft, a drive gear 12 configured to rotate together with the motor shaft 111 in an integrated manner, a deceleration mechanism 13 configured to decelerate the rotation of the drive gear 12, a driven gear 14 configured to rotate upon receipt of a torque transmitted via the deceleration mechanism 13, a differential device 15 including a differential case 151 configured to rotate together with the driven gear 14 in an integrated manner, first and second output shafts 161, 162 connected to respective side gears 154 provided in a pair in the differential device 15 in a relatively non-rotatable manner, and a housing 2 in which these members are accommodated. The motor shaft 111 has a hollow tube shape, and the second output shaft 162 is passed through the motor shaft 111.

The housing 2 is supported in a non-rotatable manner relative to a vehicle body. A drive shaft 109a connected to the left rear wheel 103 is attached to the first output shaft 161, and a drive shaft 109b connected to the right rear wheel 104 is attached to the second output shaft 162. The electric motor 11 receives supply of a motor current from the control device 100, so that the motor shaft 111 rotates at a torque corresponding to the motor current.

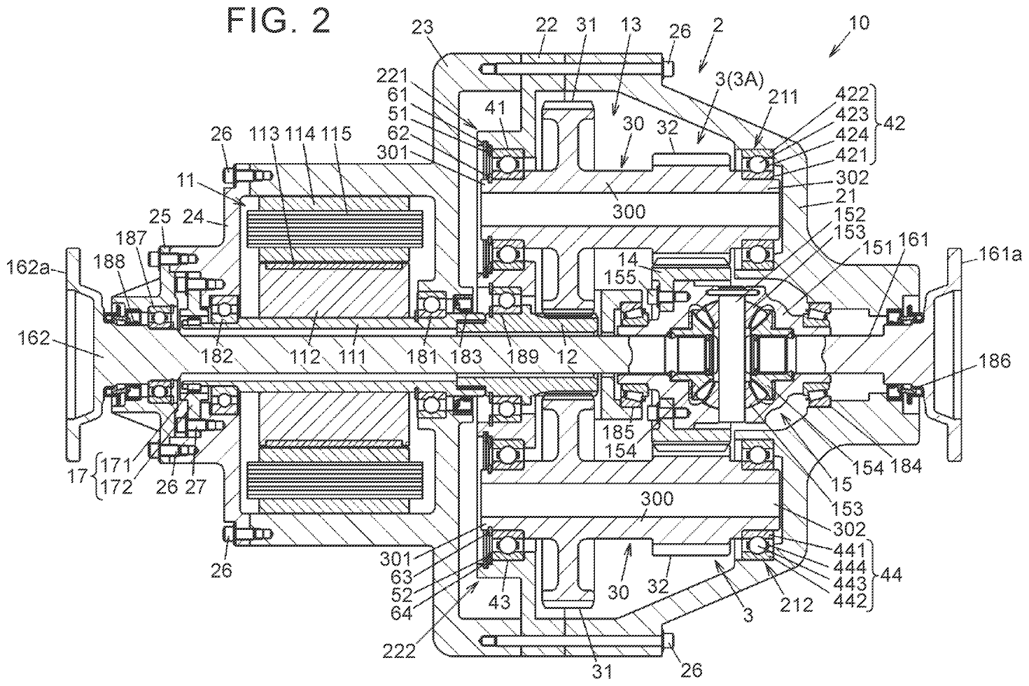

FIG. 2 is a sectional view illustrates an exemplary configuration of the driving device 10. FIG. 2 illustrates a state of the driving device 10 viewed from the front side toward the rear side in the vehicle front-rear direction. The right side of the figure corresponds to the left side of the vehicle, and the left side of the figure corresponds to the right side of the vehicle. Further, in the following discussion, “left” and “right” indicate “left” and “right” on FIG. 2. However, the left and the right as used herein do not restrict the arrangement of the driving device 10 at the time when the driving device 10 is provided in the vehicle.

The housing 2 includes first to fifth housing members 21 to 25 sequentially from the right side, and the housing members 21 to 25 are fixed to each other by a plurality of bolts 26. The first to fifth housing members 21 to 25 are made of aluminum alloy, for example, and are formed by die-casting. The electric motor 11 is accommodated in the third housing member 23, and a left opening of the third housing member 23 is closed by the fourth housing member 24. The fifth housing member 25 is fixed further on the left side of the fourth housing member 24.

The deceleration mechanism 13, the driven gear 14, and the differential device 15 are accommodated in the first and second housing members 21, 22. Lubricant (not illustrated) is filled in the first and second housing members 21, 22. A sliding portion or a meshing portion between members out of the deceleration mechanism 13, the driven gear 14, and the differential device 15 is lubricated by the lubricant.

The electric motor 11 includes a motor shaft 111, a rotor core 112 configured to rotate together with the motor shaft 111 in an integrated manner, a plurality of permanent magnets 113 fixed to the rotor core 112, a stator core 114 placed on an outer periphery of the rotor core 112, and winding wires 115 including a plurality of phases and wound around the stator core 114. The stator core 114 is fixed to the third housing member 23. Motor currents of the phases are supplied to the winding wires 115 of the phases from the control device 100.

The rotation angle of the motor shaft 111 from the housing 2 is detected by a rotation angle sensor 17. The rotation angle sensor 17 is constituted by a resolver rotor 171 fixed to the motor shaft 111, and a resolver sensor 172 fixed to the fourth housing member 24 by bolts 27. A detection signal of the resolver sensor 172 is sent to the control device 100. The control device 100 controls the electric motor 11 based on vehicle information. The vehicle information includes rotation speeds of the right and left front wheels 102, 101 and the right and left rear wheels 104, 103, an accelerator positions, a steering angle, and so on.

The motor shaft 111 is rotatably supported by a bearing 181 and a bearing 182. The bearing 181 is held by the third housing member 23, and the bearing 182 is held by the fourth housing member 24. Further, a sealing member 183 is placed adjacent to the bearing 181 between the third housing member 23 and the motor shaft 111.

The differential device 15 includes a differential case 151, a pinion shaft 152 fixed to the differential case 151, a pair of pinion gears 153 supported by the pinion shaft 152, and a pair of side gears 154 provided such that the side gears 154 mesh with the pinion gears 153 with their gear shafts being perpendicular to each other. The differential case 151 is rotatably supported by a bearing 184 and a bearing 185. The bearing 184 is held by the first housing member 21, and the bearing 185 is held by the second housing member 22.

The first output shaft 161 is splined to the right side gear 154 out of the side gears 154 and rotates together with the right side gear 154 in an integrated manner. Further, the first output shaft 161 includes a flange portion 161a to which a drive shaft 109a provided on the left side in the vehicle right-left direction is attached. The flange portion 161a projects rightward from the first housing member 21. A sealing member 186 is placed between the first output shaft 161 and the first housing member 21.

The second output shaft 162 is splined to the left side gear 154 out of the side gears 154 and rotates together with the left side gear 154 in an integrated manner. Further, the second output shaft 162 includes a flange portion 162a to which a drive shaft 109b provided on the right side in the vehicle right-left direction is attached. The flange portion 162a projects leftward from the fifth housing member 25. A bearing 187 and a sealing member 188 are placed between the second output shaft 162 and the fifth housing member 25.

The drive gear 12 is splined to a right end part of the motor shaft 111 and rotates together with the motor shaft 111 in an integrated manner. The drive gear 12 is supported by a bearing 189 held by the second housing member 22. External teeth are formed on an outer peripheral surface of the drive gear 12. Note that, in the present embodiment, the drive gear 12 is provided separately from the motor shaft 111, but the drive gear 12 may be formed integrally with the motor shaft 111.

The deceleration mechanism 13 includes a plurality of reduction gear shafts 3, first or fourth bearings 41 to 44 held by the housing 2 so as to support the reduction gear shafts 3, and first and second coned disc springs 51, 52 as biasing members. In the present embodiment, the deceleration mechanism 13 includes two reduction gear shafts 3 having the same shape, and the two reduction gear shafts 3 are placed in parallel to each other across the drive gear 12 and the driven gear 14. The deceleration mechanism 13 decelerates rotation of the drive gear 12 and transmits a torque of the electric motor 11 to the driven gear 14. The driven gear 14 is driven to rotate by the torque of the electric motor 11, the torque being transmitted via the deceleration mechanism 13.

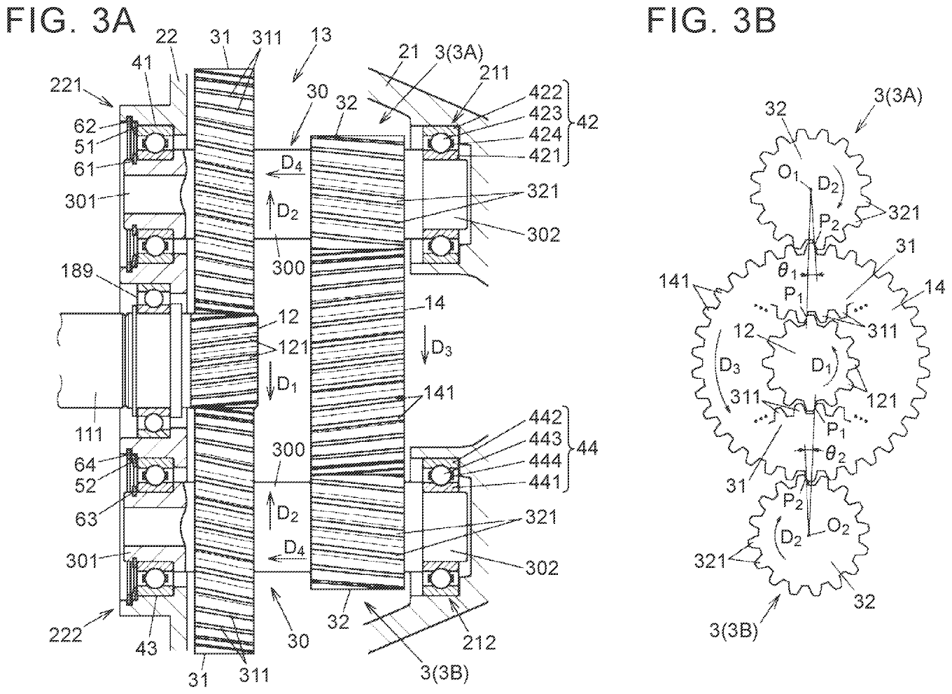

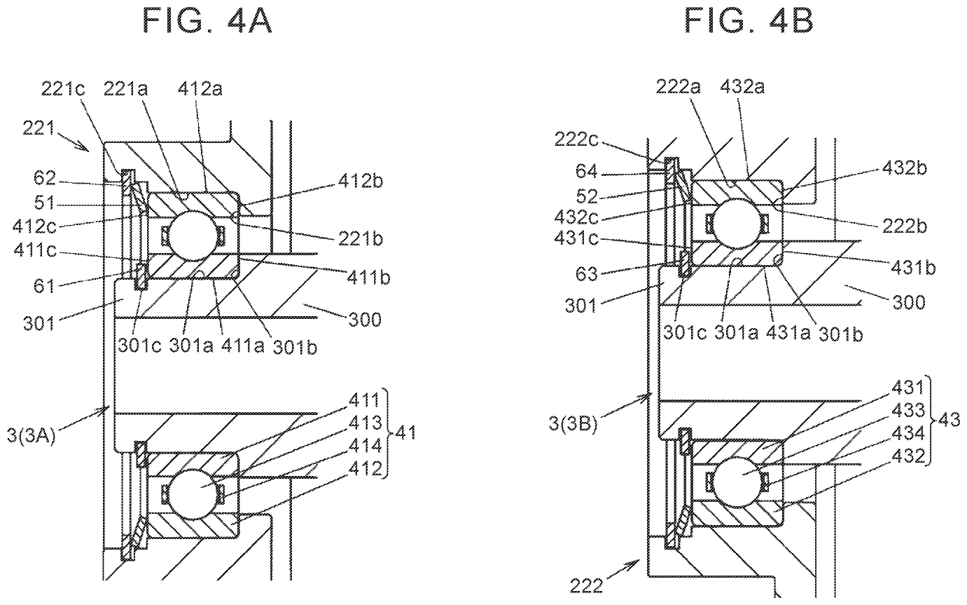

FIG. 3A is a configuration diagram illustrating the drive gear 12, the deceleration mechanism 13, and the driven gear 14 together with a section of part of the first housing member 21 and the second housing member 22. FIG. 3B is an explanatory view schematically illustrating a meshing state where the drive gear 12, the deceleration mechanism 13, and the driven gear 14 are meshed, when they are viewed from the differential device 15 side (the right side on the figure) toward the electric motor 11 side (the left side on the figure). FIG. 4A is a partial enlarged view of FIG. 3A and illustrates the first bearing 41 and its peripheral part in an enlarged manner. FIG. 4B is a partial enlarged view of FIG. 3A and illustrates the third bearing 43 and its peripheral part in an enlarged manner.

Each of the reduction gear shafts 3 includes a shaft portion 30 placed in parallel to the motor shaft 111, a large-diameter gear wheel 31 meshing with the drive gear 12, and a small-diameter gear wheel 32 meshing with the driven gear 14. The large-diameter gear wheel 31 and the small-diameter gear wheel 32 are concentrically provided in the shaft portion 30. The shaft portion 30 includes a connecting portion 300, a first supported portion 301, and a second supported portion 302. The connecting portion 300 penetrates through the large-diameter gear wheel 31 and the small-diameter gear wheel 32 so as to connect the large-diameter gear wheel 31 and the small-diameter gear wheel 32 to each other such that the large-diameter gear wheel 31 and the small-diameter gear wheel 32 rotate together in an integrated manner. The first supported portion 301 projects leftward (toward the second housing member 22 side) from the connecting portion 300. The second supported portion 302 projects rightward (toward the first housing member 21 side) from the connecting portion 300.

The first supported portion 301 corresponds to an end part, on the large-diameter gear wheel 31 side, of the shaft portion 30, and the second supported portion 302 corresponds to an end part, on the small-diameter gear wheel 32 side, of the shaft portion 30. The first supported portion 301 and the second supported portion 302 have outside diameters smaller than that of the connecting portion 300, so that respective annular steps are formed between the first supported portion 301 and the connecting portion 300 and between the second supported portion 302 and the connecting portion 300.

Hereinafter, in a case where it is necessary to distinguish the two reduction gear shafts 3 from each other, one of the reduction gear shafts 3 is referred to as a first reduction gear shaft 3A, and the other one of the reduction gear shafts 3 is referred to as a second reduction gear shaft 3B. The first reduction gear shaft 3A is supported by the first and second bearings 41, 42, and the second reduction gear shaft 3B is supported by the third and fourth bearings 43, 44. The first and third bearings 41, 43 are held by the second housing member 22, and the second and fourth bearings 42, 44 are held by the first housing member 21.

The first to fourth bearings 41 to 44 are rolling bearings each including a plurality of rolling elements. The first to fourth bearings 41 to 44 each include an inner ring 411, 421, 431, 441, an outer ring 412, 422, 432, 442, and a plurality of spherical rollers 413, 423, 433, 443 placed between the inner ring 411, 421, 431, 441 and the outer ring 412, 422, 432, 442. The inner rings 411, 431 of the first and third bearings 41, 43 are outwardly engaged to the first supported portions 301 of the reduction gear shafts 3, respectively, and the inner rings 421, 441 of the second and fourth bearings 42, 44 are outwardly engaged to the second supported portions 302 of the reduction gear shafts 3, respectively.

The outer rings 412, 422, 432, 442 of the first to fourth bearings 41 to 44 are held by first to fourth outer ring holding portions 221, 211, 222, 212 of the housing 2, respectively. The first outer ring holding portion 221 configured to hold the outer ring 412 of the first bearing 41 and the third outer ring holding portion 222 configured to hold the outer ring 432 of the third bearing 43 are provided in the second housing member 22. The second outer ring holding portion 211 configured to hold the outer ring 422 of the second bearing 42 and the fourth outer ring holding portion 212 configured to hold the outer ring 442 of the fourth bearing 44 are provided in the first housing member 21. Note that, in the present embodiment, the first to fourth bearings 41 to 44 are ball bearings. However, they are not limited to this, and the second and fourth bearings 42, 44 may be needle roller bearings (needle bearings).

The drive gear 12, the driven gear 14, and the large-diameter gear wheel 31 and the small-diameter gear wheel 32 of the reduction gear shaft 3 are formed as helical gears such that the flank lines of external teeth 121, 141, 311, 321 are inclined from the axial direction. The inclination directions of the flank lines are set to directions to cause thrust forces toward the second housing member 22 side (the left side in FIGS. 2, 3A) in the reduction gear shafts 3 as a whole when the electric motor 11 generates a torque in a main rotation direction. Here, the main rotation direction is a rotation direction of the motor shaft 111 when the vehicle 1 advances.

In FIG. 3B, respective rotation directions of the drive gear 12, the first and second reduction gear shafts 3A, 3B, and the driven gear 14 when the vehicle 1 advances are indicated by arrows D₁, D₂, D₃, respectively, and a direction of the thrust forces to be caused in the reduction gear shafts 3 when the electric motor 11 generates a torque to advance the vehicle 1 is indicated by D₄. In the present embodiment, the inclination direction of the flank line of the large-diameter gear wheel 31 is the same as the inclination direction of the flank line of the small-diameter gear wheel 32, and the direction of a thrust force to be caused in the large-diameter gear wheel 31 due to meshing with the drive gear 12 is reverse to the direction of a thrust force to be caused in the small-diameter gear wheel 32 due to meshing with the driven gear 14. However, since a torque to be transmitted between the driven gear 14 and the small-diameter gear wheel 32 is larger than a torque to be transmitted between the drive gear 12 and the large-diameter gear wheel 31, the latter thrust force is more dominant. Note that either the drive gear 12 and the large-diameter gear wheel 31 or the driven gear 14 and the small-diameter gear wheel 32 (e.g., the drive gear 12 and the large-diameter gear wheel 31) may be spur gears.

When motor currents are supplied to the electric motor 11 from the control device 100, the torque of the electric motor 11 is transmitted to the drive gear 12, and the torque is further transmitted to the driven gear 14 from the drive gear 12 via the deceleration mechanism 13. Since the deceleration mechanism 13 includes the two reduction gear shafts 3, the torque transmitted to the drive gear 12 is split to the two reduction gear shafts 3 and then transmitted to the driven gear 14.

It is preferable that the tooth contact between the large-diameter gear wheel 31 and the drive gear 12 and the tooth contact between the small-diameter gear wheel 32 and the driven gear 14 in one of the two reduction gear shafts 3 be completely synchronous with those in the other one of them. When the tooth contacts are synchronous with each other as such, the torque can be evenly split to the two reduction gear shafts 3, thereby making it possible to prevent a load to either one of the reduction gear shafts 3 from excessively increasing.

Note that a state where the tooth contacts are synchronous with each other indicates a state where the reduction gear shafts 3 have the same teeth abutment timing, so that a torque to be transmitted between teeth in one of the reduction gear shafts 3 is equal to that in the other one of the reduction gear shafts 3. More specifically, as illustrated in FIG. 3B, when a point where the external tooth 121 of the drive gear 12 abuts with the external tooth 311 of the large-diameter gear wheel 31 is assumed a contact point P₁, and a point where the external tooth 141 of the driven gear 14 abuts with the external tooth 321 of the small-diameter gear wheel 32 is assumed a contact point P₂, an angle θ₁ formed between a straight line that connects a rotation center θ₁ of the first reduction gear shaft 3A to the contact point P₁ and a straight line that connects the rotation center θ₁ to the contact point P₂ is always the same as an angle θ₂ formed between a straight line that connects a rotation center θ₂ of the second reduction gear shaft 3B to the contact point P₁ and a straight line that connects the rotation center θ₂ to the contact point P₂.

However, the large-diameter gear wheel 31 and the small-diameter gear wheel 32 are helical gears as described above. Accordingly, when relative axial positions of the two reduction gear shafts 3 are displaced from each other, the tooth contacts of the large-diameter gear wheel 31 and the small-diameter gear wheel 32 in one of the two reduction gear shafts 3 are not synchronous with the tooth contacts of the large-diameter gear wheel 31 and the small-diameter gear wheel 32 in the other one of the two reduction gear shafts 3. For example, in a case where the first reduction gear shaft 3A is displaced rightward in the figure from the second reduction gear shaft 3B, the tooth contacts of the large-diameter gear wheel 31 and the small-diameter gear wheel 32 in the first reduction gear shaft 3A become stronger than the tooth contacts of the large-diameter gear wheel 31 and the small-diameter gear wheel 32 in the second reduction gear shaft 3B. As a result, a torque to be transmitted by the first reduction gear shaft 3A becomes larger than a torque to be transmitted by the second reduction gear shaft 3B.

Such a displacement between the relative axial positions of the first and second reduction gear shafts 3A, 3B can occur due to axial backlashes of the first to fourth bearings 41 to 44 from the housing 2, for example. Further, a dimension error at the time of molding of the first housing member 21 or the second housing member 22 or a distortion caused when the first to third housing members 21 to 23 are fastened by the bolts 26 can also cause a displacement between the relative axial positions of the first and second reduction gear shafts 3A, 3B.

In the present embodiment, the outer ring 412 of the first bearing 41 is axially biased by the first coned disc spring 51 provided for the first bearing 41, and the outer ring 432 of the third bearing 43 is axially biased by the second coned disc spring 52 provided for the third bearing 43. Hereby, the torque to be transmitted by the first reduction gear shaft 3A and the torque to be transmitted by the second reduction gear shaft 3B are equalized to each other. The first and second coned disc springs 51, 52 are one example of a biasing member in the present disclosure. Next will be described details of bearing support structures in the first and second reduction gear shafts 3A, 3B in the present embodiment.

As illustrated in FIG. 4A, in the first reduction gear shaft 3A, an outer peripheral surface 301a of the first supported portion 301 faces an inner peripheral surface 411a of the inner ring 411 of the first bearing 41, and a stepped surface 301b between the connecting portion 300 and the first supported portion 301 faces a first side face 411b of the inner ring 411. The inner ring 411 is fitted by pressing into the outer peripheral surface 301a of the first supported portion 301. An annular outer peripheral groove 301c is formed in the first supported portion 301, and a snap ring 61 is fitted in the outer peripheral groove 301c. The snap ring 61 is a snap ring constituted by a C-shaped spring steel in an axial view. The snap ring 61 faces a second side face 411c of the inner ring 411 and retains the inner ring 411 such that the inner ring 411 does not fall from the first supported portion 301.

Part of the second housing member 22 is formed as the first outer ring holding portion 221 configured to hold the outer ring 412 of the first bearing 41. The first outer ring holding portion 221 includes an inner peripheral surface 221a facing an outer peripheral surface 412a of the outer ring 412, and a side wall surface 221b facing a first side face 412b of the outer ring 412. The outer ring 412 is loosely fitted into the inner peripheral surface 221a of the first outer ring holding portion 221. Further, an annular inner peripheral groove 221c is formed in the first outer ring holding portion 221, and a snap ring 62 is fitted in the inner peripheral groove 221c.

The first coned disc spring 51 is placed in an axially compressed state between the snap ring 62 and a second side face 412c of the outer ring 412. Further, an end part, on the outer peripheral side, of the first coned disc spring 51 abuts with the snap ring 62, and an end part, on the inner peripheral side, of the first coned disc spring 51 abuts with the second side face 412c of the outer ring 412, so that the first coned disc spring 51 biases the outer ring 412 toward the side wall surface 221b. When the electric motor 11 does not generate a torque, the first side face 412b of the outer ring 412 abuts with the side wall surface 221b by being pressed against the side wall surface 221b by a restoring force of the first coned disc spring 51. Further, when the electric motor 11 generates a torque to advance the vehicle 1, the first coned disc spring 51 is compressed by a thrust force caused in the first reduction gear shaft 3A, so that the first side face 412b of the outer ring 412 is separated from the side wall surface 221b.

In the second reduction gear shaft 3B, the first supported portion 301 is supported by the third bearing 43 by a bearing support structure similar to the bearing support structure of the first reduction gear shaft 3A. As illustrated in FIG. 4B, an inner peripheral surface 431a of the inner ring 431 of the third bearing 43 faces the outer peripheral surface 301a of the first supported portion 301, and a first side face 431b of the inner ring 431 faces the stepped surface 301b. A snap ring 63 fitted in the outer peripheral groove 301c of the first supported portion 301 faces a second side face 431c of the inner ring 431, and the snap ring 63 retains the inner ring 431 such that the inner ring 431 does not fall.

An outer peripheral surface 432a of the outer ring 432 of the third bearing 43 faces an inner peripheral surface 222a of the third outer ring holding portion 222 of the second housing member 22, and a first side face 432b of the outer ring 432 faces a side wall surface 222b of the third outer ring holding portion 222. An end part, on the inner peripheral side, of the second coned disc spring 52 abuts with a second side face 432c of the outer ring 432. An end part, on the outer peripheral side, of the second coned disc spring 52 abuts with a snap ring 64 fitted in an annular inner peripheral groove 222c formed in the third outer ring holding portion 222. When the electric motor 11 does not generate a torque, the first side face 432b of the outer ring 432 abuts with the side wall surface 222b by being pressed against the side wall surface 222b by a restoring force of the second coned disc spring 52. Further, when the electric motor 11 generates a torque to advance the vehicle 1, the second coned disc spring 52 is compressed by a thrust force caused in the second reduction gear shaft 3B, so that the first side face 432b of the outer ring 432 is separated from the side wall surface 222b.

The first coned disc spring 51 and the second coned disc spring 52 are made of the same material and have the same size and also have the same spring constant. The spring constants of the first coned disc spring 51 and the second coned disc spring 52 have a value at which they are not fully compressed even when the electric motor 11 generates a maximum torque (rated torque).

Since the first coned disc spring 51 axially biases the outer ring 412 of the first bearing 41, the position of the first bearing 41 relative to the first outer ring holding portion 221 is stable, so that the axial position of the first reduction gear shaft 3A is stable. Further, since the second coned disc spring 52 axially biases the outer ring 432 of the third bearing 43, the position of the third bearing 43 relative to the third outer ring holding portion 222 is stable, so that the axial position of the second reduction gear shaft 3B is stable. This can restrain a displacement between the relative axial positions of the first and second reduction gear shafts 3A, 3B, so that the torque to be transmitted by the first reduction gear shaft 3A and the torque to be transmitted by the second reduction gear shaft 3B can be equalized to each other.

Further, in the present embodiment, the first coned disc spring 51 is placed at a position where the first coned disc spring 51 is compressed by the thrust force of the first reduction gear shaft 3A to be caused in the direction of D₄ illustrated in FIG. 3A, and the second coned disc spring 52 is placed at a position where the second coned disc spring 52 is compressed by the thrust force of the second reduction gear shaft 3B to be caused in the direction of D₄ also illustrated in FIG. 3A. Accordingly, even when the axial positions of the first outer ring holding portion 221 and the third outer ring holding portion 222 are displaced from each other due to a dimension error of the second housing member 22, for example, the torque to be transmitted by the first reduction gear shaft 3A and the torque to be transmitted by the second reduction gear shaft 3B can be equalized to each other by relaxing the influence caused due to the positional displacement.

That is, if the first outer ring holding portion 221 is placed on a side closer to the first housing member 21 side than the third outer ring holding portion 222, and this causes the first reduction gear shaft 3A to be displaced closer to the first housing member 21 side than the second reduction gear shaft 3B, the meshing phase of the small-diameter gear wheel 32 of the first reduction gear shaft 3A with the driven gear 14 advances more than the meshing phase of the small-diameter gear wheel 32 of the second reduction gear shaft 3B with the driven gear 14. As a result, the torque to be transmitted by the first reduction gear shaft 3A becomes larger than the torque to be transmitted by the second reduction gear shaft 3B. In this case, the thrust force to be caused in the first reduction gear shaft 3A becomes larger than the thrust force to be caused in the second reduction gear shaft 3B, so that the first coned disc spring 51 is more largely compressed in the axial direction than the second coned disc spring 52. As a result, a positional displacement amount of the first reduction gear shaft 3A relative to the second reduction gear shaft 3B is reduced, so that their transmission torques are equalized to each other. Note that this also applies to a case where the third outer ring holding portion 222 is placed on a side closer to the first housing member 21 side than the first outer ring holding portion 221.

### Second Embodiment

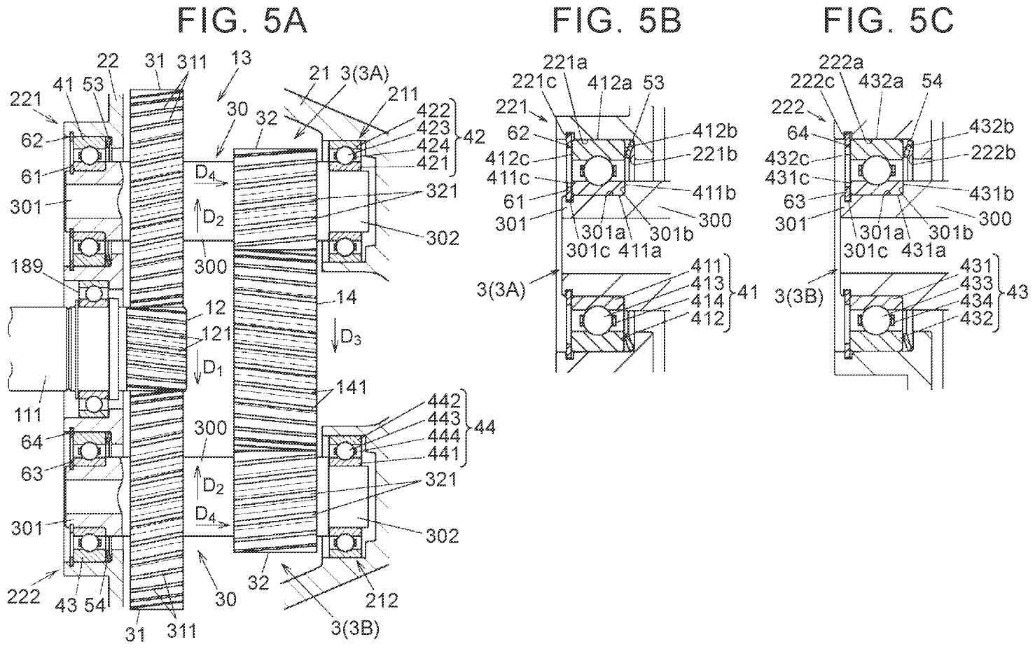

Next will be described a second embodiment of the present disclosure with reference to FIGS. 5A, 5B, 5C. FIG. 5A is a configuration diagram illustrating the drive gear 12, the deceleration mechanism 13, and the driven gear 14 in the second embodiment together with a section of part of the first housing member 21 and the second housing member 22. FIG. 5B is a partial enlarged view of FIG. 5A and illustrates the first bearing 41 and its peripheral part in an enlarged manner. FIG. 5C is a partial enlarged view of FIG. 5A and illustrates the third bearing 43 and its peripheral part in an enlarged manner. In FIGS. 5A to 5C, constituents common to those described in the first embodiment have the same reference signs used in FIGS. 3A, 3B, and redundant descriptions are omitted.

As illustrated in FIG. 5A, in the present embodiment, twisting directions of the flank lines of the external teeth 121, 311, 321, 141 of the drive gear 12, the large-diameter gear wheels 31 and the small-diameter gear wheels 32 of the reduction gear shafts 3, and the driven gear 14 are reverse to those in the first embodiment. Accordingly, the direction (the arrows D₄) of thrust forces to be caused in the reduction gear shafts 3 at the time when the electric motor 11 generates a torque to advance the vehicle 1 is reverse to that in the first embodiment.

Further, in the present embodiment, a first coned disc spring 53 is placed between the first side face 412b of the outer ring 412 of the first bearing 41 and the side wall surface 221b of the first outer ring holding portion 221, and a second coned disc spring 54 is placed between the first side face 432b of the outer ring 432 of the third bearing 43 and the side wall surface 222b of the third outer ring holding portion 222. The position where the first coned disc spring 53 is placed is a position where the first coned disc spring 53 is axially compressed by a thrust force caused in the first reduction gear shaft 3A, and the position where the second coned disc spring 54 is placed is a position where the second coned disc spring 54 is axially compressed by a thrust force caused in the second reduction gear shaft 3B. The spring constants of the first coned disc spring 53 and the second coned disc spring 54 have the same value. Further, the spring constants of the first coned disc spring 53 and the second coned disc spring 54 are set to a value at which they are not fully compressed even when the electric motor 11 generates a maximum torque (rated torque).

When the electric motor 11 does not generate a torque, the second side face 412c of the outer ring 412 of the first bearing 41 abuts with the snap ring 62 by a restoring force of the first coned disc spring 53, and the second side face 432c of the outer ring 432 of the third bearing 43 abuts with the snap ring 64 by a restoring force of the second coned disc spring 54. Further, when the electric motor 11 generates a torque to advance the vehicle 1, the first coned disc spring 53 is compressed by a thrust force caused in the first reduction gear shaft 3A, so that the second side face 412c of the outer ring 412 of the first bearing 41 is separated from the snap ring 62, and the second coned disc spring 54 is compressed by a thrust force caused in the second reduction gear shaft 3B, so that the second side face 432c of the outer ring 432 of the third bearing 43 is separated from the snap ring 64. Even with the second embodiment described above, it is possible to obtain an effect similar to the effect of the first embodiment.

### Third Embodiment

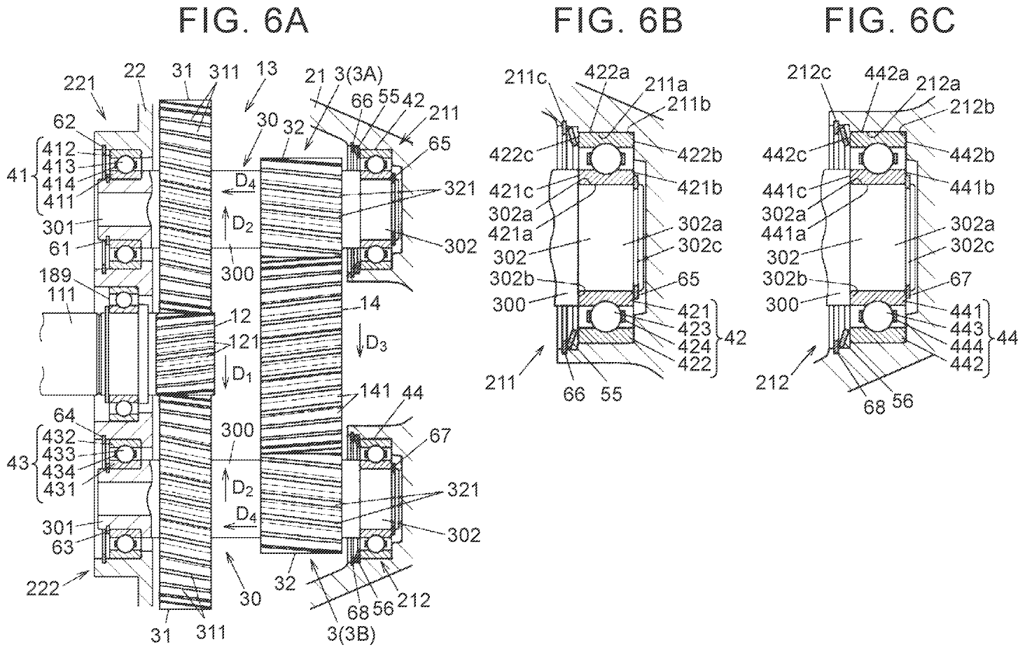

Next will be described a third embodiment of the present disclosure with reference to FIGS. 6A, 6B, 6C. FIG. 6A is a configuration diagram illustrating the drive gear 12, the deceleration mechanism 13, and the driven gear 14 in the third embodiment together with a section of part of the first housing member 21 and the second housing member 22. FIG. 6B is a partial enlarged view of FIG. 6A and illustrates the second bearing 42 and its peripheral part in an enlarged manner. FIG. 6C is a partial enlarged view of FIG. 6A and illustrates the fourth bearing 44 and its peripheral part in an enlarged manner. In FIGS. 6A to 6C, constituents common to those described in the first embodiment have the same reference signs used in FIGS. 3A, 3B, and redundant descriptions are omitted.

The first and second embodiments deal with a case where the coned disc springs 51 to 54 are placed for the first bearing 41 and the third bearing 43. However, the third embodiment and a fourth embodiment (described later) deal with a case where coned disc springs 55 to 58 as biasing members are placed for the second bearing 42 and the fourth bearing 44. The spring constants of the coned disc springs 55 to 58 have the same value and are set to a value at which they are not fully compressed even when the electric motor 11 generates a maximum torque (rated torque).

In the third embodiment, the twisting directions of the flank lines of the external teeth 121, 311, 321, 141 of the drive gear 12, the large-diameter gear wheels 31 and the small-diameter gear wheels 32 of the reduction gear shafts 3, and the driven gear 14 are the same as those in the first embodiment. When the electric motor 11 generates a torque to advance the vehicle 1, thrust forces directed from the first housing member 21 side to the second housing member 22 side are caused in the reduction gear shafts 3.

In the first reduction gear shaft 3A, an inner peripheral surface 421a of the inner ring 421 of the second bearing 42 is fitted by pressing into an outer peripheral surface 302a of the second supported portion 302. An annular stepped surface 302b is formed between the second supported portion 302 and the connecting portion 300, and an outer peripheral groove 302c in which a snap ring 65 is fitted is formed in the outer peripheral surface 302a of the second supported portion 302. A first side face 421b of the inner ring 421 of the second bearing 42 faces the snap ring 65, and a second side face 421c of the inner ring 421 faces the stepped surface 302b.

The second outer ring holding portion 211 includes an inner peripheral surface 211a facing an outer peripheral surface 422a of the outer ring 422 of the second bearing 42, and a side wall surface 211b facing a first side face 422b of the outer ring 422. The outer ring 422 is loosely fitted into the inner peripheral surface 211a of the second outer ring holding portion 211. Further, an annular inner peripheral groove 211c is formed in the second outer ring holding portion 211, and a snap ring 66 is fitted in the inner peripheral groove 211c.

The first coned disc spring 55 is placed in an axially compressed state between the snap ring 66 and a second side face 422c of the outer ring 422. An end part, on the outer peripheral side, of the first coned disc spring 55 abuts with the snap ring 66, and an end part, on the inner peripheral side, of the first coned disc spring 55 abuts with the second side face 422c of the outer ring 422, so that the first coned disc spring 55 biases the outer ring 422 toward the side wall surface 211b. When the electric motor 11 does not generate a torque, the first side face 422b of the outer ring 422 abuts with the side wall surface 211b by being pressed against the side wall surface 211b by a restoring force of the first coned disc spring 55. When the electric motor 11 generates a torque to advance the vehicle 1, the first coned disc spring 55 is compressed by a thrust force caused in the first reduction gear shaft 3A, so that the first side face 422b of the outer ring 422 is separated from the side wall surface 211b.

In the second reduction gear shaft 3B, a snap ring 67 is fitted in an outer peripheral groove 302c formed in the outer peripheral surface 302a of the second supported portion 302. An inner peripheral surface 441a of the inner ring 441 of the fourth bearing 44 is fitted by pressing into the outer peripheral surface 302a of the second supported portion 302 of the second reduction gear shaft 3B such that a first side face 441b of the inner ring 441 faces the snap ring 67, and a second side face 441c of the inner ring 441 faces the stepped surface 302b.

The fourth outer ring holding portion 212 includes an inner peripheral surface 212a facing an outer peripheral surface 442a of the outer ring 442 of the fourth bearing 44, and a side wall surface 212b facing a first side face 442b of the outer ring 442. The outer ring 442 is loosely fitted into the inner peripheral surface 212a of the fourth outer ring holding 212. Further, an annular inner peripheral groove 212c is formed in the fourth outer ring holding portion 212, and a snap ring 68 is fitted in the inner peripheral groove 212c.

The second coned disc spring 56 is placed in an axially compressed state between the snap ring 68 and a second side face 442c of the outer ring 442. An end part, on the outer peripheral side, of the second coned disc spring 56 abuts with the snap ring 68, and an end part, on the inner peripheral side, of the second coned disc spring 56 abuts with the second side face 442c of the outer ring 442, so that the second coned disc spring 56 biases the outer ring 442 toward the side wall surface 212b. When the electric motor 11 does not generate a torque, the first side face 442b of the outer ring 442 abuts with the side wall surface 212b by being pressed against the side wall surface 212b by a restoring force of the second coned disc spring 56. When the electric motor 11 generates a torque to advance the vehicle 1, the second coned disc spring 56 is compressed by a thrust force caused in the second reduction gear shaft 3B, so that the first side face 442b of the outer ring 442 is separated from the side wall surface 212b.

The position where the first coned disc spring 55 is placed is a position where the first coned disc spring 55 is compressed by the thrust force caused in the first reduction gear shaft 3A, and the position where the second coned disc spring 56 is placed is a position where the second coned disc spring 56 is compressed by the thrust force caused in the second reduction gear shaft 3B. Even with the third embodiment described above, it is possible to obtain an effect similar to the effect of the first embodiment.

### Fourth Embodiment

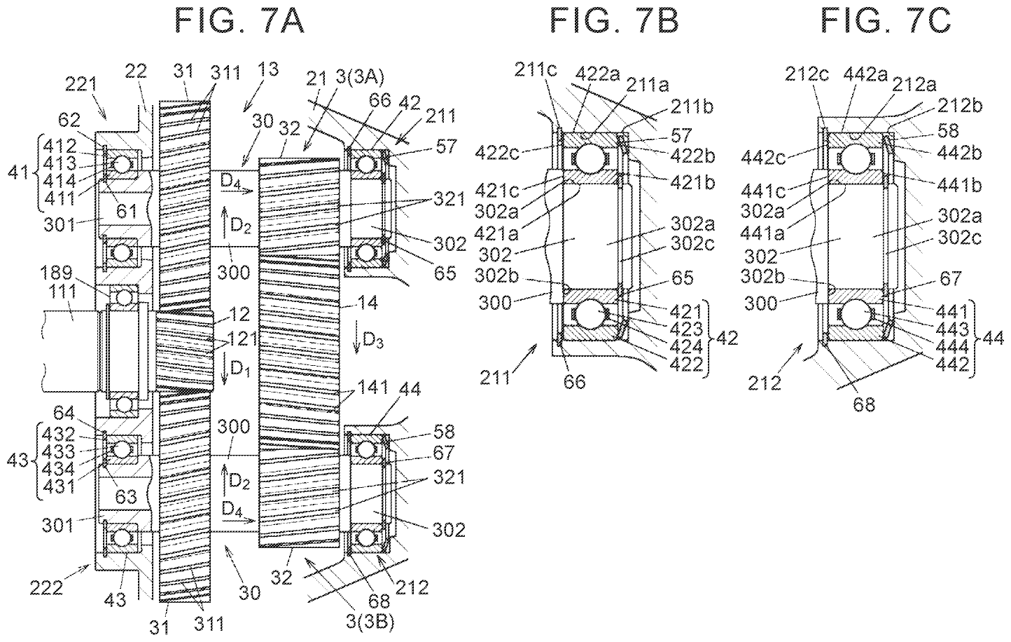

Next will be described the fourth embodiment of the present disclosure with reference to FIGS. 7A, 7B, 7C. FIG. 7A is a configuration diagram illustrating the drive gear 12, the deceleration mechanism 13, and the driven gear 14 in the fourth embodiment together with a section of part of the first housing member 21 and the second housing member 22. FIG. 7B is a partial enlarged view of FIG. 7A and illustrates the second bearing 42 and its peripheral part in an enlarged manner. FIG. 7C is a partial enlarged view of FIG. 7A and illustrates the fourth bearing 44 and its peripheral part in an enlarged manner. In FIGS. 7A to 7C, constituents common to those described in the first embodiment have the same reference signs used in FIGS. 3A, 3B, and redundant descriptions are omitted. In FIGS. 7A, 7B, 7C, constituents common to those described in the third embodiment have the same reference signs used in FIGS. 6A, 6B, 6C, and redundant descriptions are omitted.

In the fourth embodiment, the twisting directions of the flank lines of the external teeth 121, 311, 321, 141 of the drive gear 12, the large-diameter gear wheels 31 and the small-diameter gear wheels 32 of the reduction gear shafts 3, and the driven gear 14 are the same as those in the second embodiment. When the electric motor 11 generates a torque to advance the vehicle 1, thrust forces directed from the second housing member 22 side toward the first housing member 21 side are caused in the reduction gear shafts 3.

In the present embodiment, the first coned disc spring 57 is placed for the second bearing 42 that supports the first reduction gear shaft 3A, and the second coned disc spring 58 is placed for the fourth bearing 44 that supports the second reduction gear shaft 3B. The first coned disc spring 57 is placed in an axially compressed state between the first side face 422b of the outer ring 422 of the second bearing 42 and the side wall surface 211b of the second outer ring holding portion 211, so that the first coned disc spring 57 biases the outer ring 422 toward the snap ring 66. When the electric motor 11 does not generate a torque, the second side face 422c of the outer ring 422 abuts with the snap ring 66 by being pressed against the snap ring 66. When the electric motor 11 generates a torque to advance the vehicle 1, the first coned disc spring 57 is compressed by a thrust force caused in the first reduction gear shaft 3A, so that the second side face 422c of the outer ring 422 is separated from the snap ring 66.

The second coned disc spring 58 is placed in an axially compressed state between the first side face 442b of the outer ring 442 of the fourth bearing 44 and the side wall surface 212b of the fourth outer ring holding portion 212, so that the second coned disc spring 58 biases the outer ring 442 toward the snap ring 68. When the electric motor 11 does not generate a torque, the second side face 442c of the outer ring 442 abuts with the snap ring 68 by being pressed against the snap ring 68. When the electric motor 11 generates a torque to advance the vehicle 1, the second coned disc spring 58 is compressed by a thrust force caused in the second reduction gear shaft 3B, so that the second side face 442c of the outer ring 442 is distanced from the snap ring 68.

The position where the first coned disc spring 57 is placed is a position where the first coned disc spring 57 is compressed by the thrust force caused in the first reduction gear shaft 3A, and the position where the second coned disc spring 58 is placed is a position where the second coned disc spring 58 is compressed by the thrust force caused in the second reduction gear shaft 3B. Even with the fourth embodiment described above, it is possible to obtain an effect similar to the effect of the first embodiment.

Additional Matters

The present disclosure has been described based on the first to fourth embodiments, but these embodiments do not limit the disclosure according to Claims. Further, it should be noted that all combinations of features described in the embodiments may not necessarily be essential to the means for solving the problem of the disclosure.

Further, the present disclosure can be performed with various modifications within a range that does not deviate from the gist of the present disclosure. The present disclosure can be performed in combination of the configurations of the first to fourth embodiments or can be performed in the following modifications.

The first to fourth embodiments deal with a case where the coned disc springs 51 to 58 are placed at positions where they are compressed by thrust forces to be caused in the reduction gear shafts 3 at the time when the electric motor 11 generates a torque to advance the vehicle 1. Coned disc springs may be placed at positions other than this, so that the coned disc springs axially bias the outer rings 412, 422, 432, 442 in the same direction as the thrust forces caused in the reduction gear shafts 3. More specifically, as a modification of the first embodiment, for example, instead of the first coned disc spring 51 and the second coned disc spring 52, a coned disc spring may be placed between the first side face 412b of the outer ring 412 of the first bearing 41 and the side wall surface 221b of the first outer ring holding portion 221 such that the second side face 412c of the outer ring 412 abuts with the snap ring 62, and a coned disc spring may be placed between the first side face 432b of the outer ring 432 of the third bearing 43 and the side wall surface 222b of the third outer ring holding portion 222 such that the second side face 432c of the outer ring 432 abuts with the snap ring 64. Even in this case, axial backlashes of the first bearing 41 and the third bearing 43 are restrained, so that a torque to be transmitted by the first reduction gear shaft 3A and a torque to be transmitted by the second reduction gear shaft 3B can be equalized to each other.

The first to fourth embodiments deal with a case where the deceleration mechanism 13 includes two reduction gear shafts 3, but the deceleration mechanism 13 may include three reduction gear shafts 3 or four or more reduction gear shafts 3. Note that, when the number of reduction gear shafts 3 increases, their respective large-diameter gear wheels 31 easily interfere with each other. Accordingly, it is most desirable that two reduction gear shafts 3 be placed symmetrically across the rotation axis of the drive gear 12 and the driven gear 14.

The first to fourth embodiments deal with a case where the coned disc springs 51 to 58 are used as biasing members. However, the biasing member is not limited to a coned disc spring, and an elastic body such as a waved washer, a coil spring, or rubber may be also usable.

The first to fourth embodiments deal with a case where the coned disc springs 51 to 58 are compressed by the thrust forces applied to the reduction gear shafts 3. However, the spring constants of spring members such as coned disc springs to be provided as biasing members placed adjacent to the outer rings 412, 422, 432, 442 of the first to fourth bearings 41 to 44 may have a value at which the spring members are not compressed by the thrust forces applied to the reduction gear shafts 3.

What is claimed is:

1. A driving device comprising:
an electric motor;
a drive gear configured to rotate together with an output rotating shaft of the electric motor in an integrated manner;
a deceleration mechanism configured to decelerate rotation of the drive gear;
a driven gear configured to be driven to rotate by a torque of the electric motor, the torque being transmitted via the deceleration mechanism; and
a housing in which the deceleration mechanism and the driven gear are accommodated, wherein:
at least one of the drive gear and the driven gear is provided as a helical gear;
the deceleration mechanism includes
a plurality of reduction gear shafts each including a large-diameter gear wheel meshing with the drive gear and a small-diameter gear wheel meshing with the driven gear,
a plurality of bearings provided such that the bearings support respective end parts of the reduction gear shaft to the housing, and
a biasing member provided for at least any one of the bearings;
each of the reduction gear shafts is provided such that the large-diameter gear wheel and the small-diameter gear wheel are concentrically provided in a shaft portion placed in parallel to the output rotating shaft;
each of the bearings includes
an outer ring held by the housing,
an inner ring outwardly engaged with the shaft portion of a corresponding one of the reduction gear shafts, and
a plurality of rolling elements placed between the inner ring and the outer ring; and
the biasing member axially biases the outer ring of the at least any one of the bearings that supports at least either one of end parts of the shaft portion of a corresponding one of the reduction gear shafts, the end parts including an end part on the large-diameter gear wheel side and an end part on the small-diameter gear wheel side.

2. The driving device according to claim 1, wherein the biasing member is placed at a position where the biasing member is compressed by a thrust force to be caused in the corresponding one of the reduction gear shafts when the electric motor generates a torque in a main rotating direction of the electric motor.
